(19) United States
(12) Patent Application Publication
(10) Pub. No.: US 2004/0101692 A1
(43) Pub. Date: May 27, 2004

(54) Sparkling laminate film and sparkling shaped article

(76) Inventor: Sei-no-suke Mizuno, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/685,587

(22) Filed: Oct. 16, 2003

(30) Foreign Application Priority Data
Nov. 27, 2002 (JP) JP2002-343327

(51) Int. Cl. B32B 27/00

(52) U.S. Cl. 428/422.8; 428/458

(57) ABSTRACT

A novel sparkling laminate film and sparkling shaped article superior in weathering resistance while maintaining a superior gloss, wherein a metal vapor deposited layer is formed on a front surface of a substrate, a transparent resin surface layer is formed on a surface of that metal vapor deposited layer, and a backing material is integrally bonded to the back surface of the substrate through an adhesive layer.

### BACKGROUND OF THE INVENTION

1. Field of the Invention

The present invention relates to a sparkling film and sparkling shaped article for decorative use having a metallic gloss to be used for an automobile molding etc.

2. Description of the Related Art

Extensive use is being made of moldings of automobiles, for example, having decorative laminate films giving a metallic gloss bonded on their surfaces. As such a laminate film, in the past, as shown in for example FIG. 5, there has generally been known a film comprised of a surface substrate 51 made of a transparent polyester-based resin, a metal vapor deposited layer 52 formed by sputtering of aluminum, chromium, or an alloy of the same on the back surface of the surface substrate 51, and a polyvinyl chloride or other backing material 54 integrally bonded to the back surface of the metal vapor deposited layer 52 via an adhesive layer 53.

With a laminate film using a polyester-based resin as the surface substrate 51, however, there is the problem that when used over a long period of time integrally bonded to the surface of an automobile molding or other shaped article, fine cracks (so-called “microcracks”) occur and the film gradually appears whitish. This is because a polyester-based resin has the properties of a high transparency, but a poor weathering resistance.

In view of this, as shown in FIG. 6, a laminate film comprised of a surface substrate 51 and a vinylidene fluoride or other fluorine-based surface film 56 arranged on its front surface has been proposed (for example, see Japanese Unexamined Utility Model Publication (Kokai) No. 59-135257, pages 3 to 5 and FIG. 2). With this, it is possible to compensate for the weak weathering resistance of a polyester-based resin, but the distinctive white turbidity of the fluorine-based resin is exhibited and the formation of three types of layers on the surface of the metal vapor deposited layer 52 (surface film 56, adhesive film 57, and surface substrate 51) inevitably dulls the metallic color of the metal vapor deposited layer. Note that in FIG. 6, members the same as those of this embodiment (FIG. 5) are assigned the same reference numerals.

### SUMMARY OF THE INVENTION

An object of the present invention is to provide a novel sparkling laminate film and sparkling shaped article superior in weathering resistance while maintaining a superior metallic gloss.

To attain the above object, according to a first aspect of the present invention, there is provided a sparkling laminate film comprised of a substrate, a metal vapor deposited layer formed on a front surface of the substrate, a transparent resin surface layer formed on a front surface of the metal vapor deposited layer, and a backing material integrally bonded to a back surface of the substrate through an adhesive layer.

Preferably, the substrate is comprised of a polyester-based resin with a high flexibility.

Preferably, the metal vapor deposited layer has a thickness of 150 to 750 Å.

Preferably, the transparent resin surface layer is made of one of an acryl-based resin and a urethane-based resin.

Preferably, a hue angle (H°) when measuring the color of the transparent resin surface layer is in a range of 245 to 265.

According to a second aspect of the present invention, there is provided a sparkling shaped article comprised of a shaped body and a sparkling laminate film of any of the above integrally bonded with that body.

### BRIEF DESCRIPTION OF THE DRAWINGS

These and other objects and features of the present invention will become clearer from the following description of the preferred embodiments given with reference to the attached drawings, wherein:

FIG. 1 is a schematic sectional view of a sparkling laminate film according to an embodiment of the present invention;

FIG. 2 is a sectional view of a process of forming a metal vapor deposited layer;

FIG. 3 is a sectional view of a process of forming a transparent resin surface layer;

FIG. 4 is a sectional view of an example of a sparkling shaped article;

FIG. 5 is a sectional view of an embodiment of a conventional laminate film; and

FIG. 6 is a sectional view of another embodiment of a laminate film of the related art.

### DESCRIPTION OF THE PREFERRED EMBODIMENTS

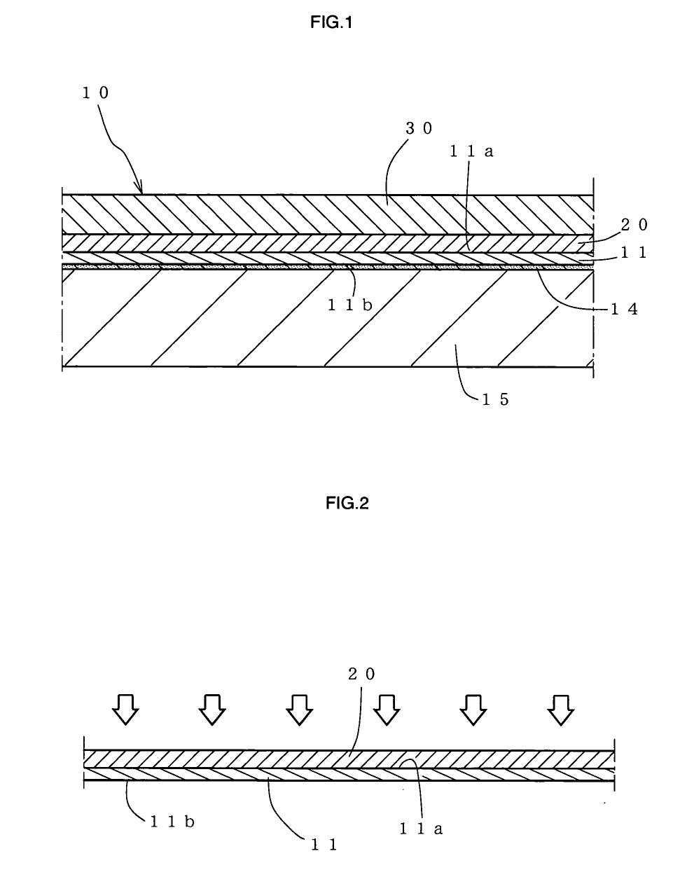

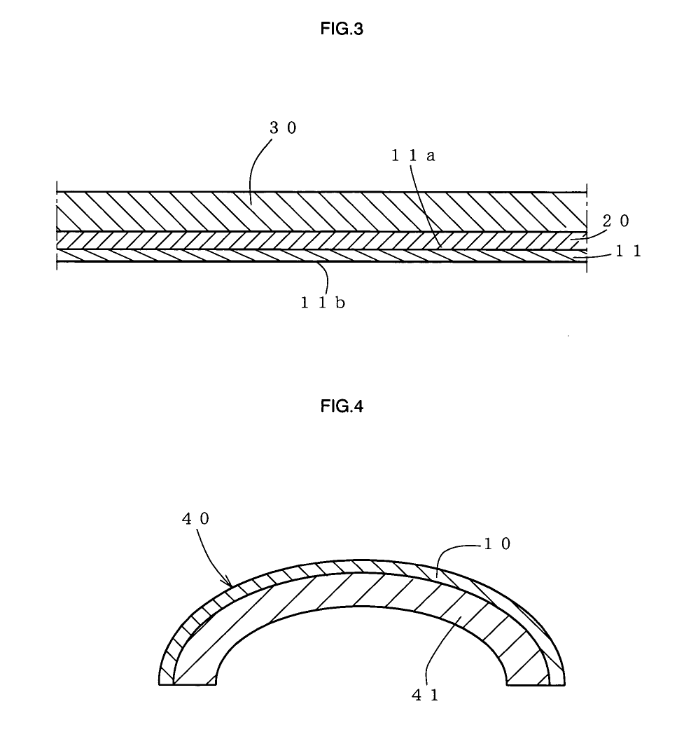

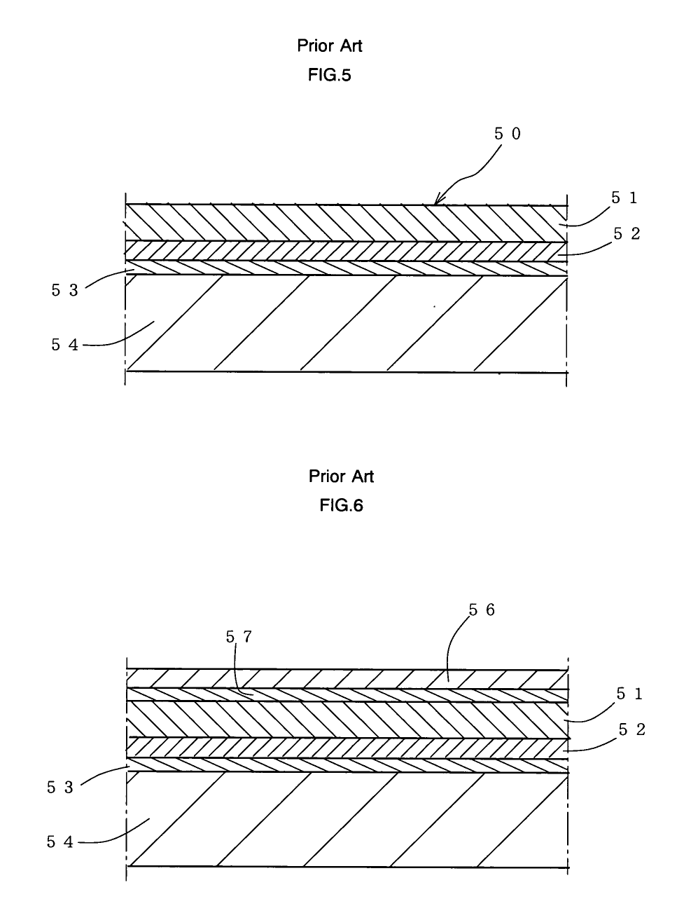

Preferred embodiments of the present invention will be described in detail below while referring to the attached figures. FIG. 1 is a schematic sectional view of a sparkling laminate film according to an embodiment of the present invention; FIG. 2 is a sectional view of a step of forming a metal vapor deposited layer; FIG. 3 is a sectional view of a step of forming a transparent resin surface layer; and FIG. 4 is a sectional view of an example of a sparkling shaped article.

As shown in FIG. 1, the sparkling laminate film 10 according to the present invention is comprised of a substrate 11, a metal vapor deposited layer 20 formed on a front surface 11a of that substrate 11, a transparent resin surface layer 30 formed on the front surface of the metal vapor deposited layer 20, and a backing material 15 integrally bonded to a back surface 11b of the substrate 11 via an adhesive layer 14.

The substrate 11 is formed with the metal vapor deposited layer 20 on it. It is preferably comprised of a polyester-based resin, particularly may include a polyterephthalate, polybutylene terephthalate, or other aromatic polyester resin and copolymer ingredient. The thickness is 12 to 100 μm, particularly preferably 25 to 50 μm. If too thin, the durability and other facets of its performance will become a problem, while if too thick, there will be problems in terms of flexibility and cost.

In this particular embodiment, the substrate 11 is preferably a polyester-based film of a thickness of 50 μm (Teflex made by Teijin Dupont). This type of polyester-based film is preferably one having flexibility and heat resistance, more preferably one having a stress at 100% elongation of 20 to 80 Mpa (usable temperature range of −70° C. to 130° C.). Note that it is also possible to prime the surface (11a) of the substrate 11 on which the metal vapor deposited layer 20 is to be formed.

The metal vapor deposited layer 20 is comprised of a vapor deposited layer of chromium or a chromium alloy or aluminum etc. formed on the surface 11a of the substrate 11. The metal vapor deposited layer 20 may be formed by known sputtering, electron beam deposition, ion plating, or another suitably selected physical film-forming method. In this embodiment, known DC magnetron sputtering was used. As the chromium or chromium alloy or aluminum, a known one may be used.

The metal vapor deposited layer 20 preferably has a thickness in the range of 150 to 750 Å, particularly 200 to 500 Å. If more than 750 Å, the metal vapor deposited layer easily cracks—which is unpreferable in terms of appearance, production, and cost, while if less than 150 Å, the targeted metal sparkling nature falls.

The transparent resin surface layer 30 is formed at the topmost layer of the sparkling laminate film 10 and gives to the outer surface a metallic gloss due to the metal vapor deposited layer 20 positioned at its back surface. The transparent resin surface layer 30 is formed by coating or forming a film on the front surface of the metal vapor deposited layer 20 formed on the substrate 11.

The transparent resin surface layer 30 is preferably comprised of an acryl-based resin or urethane-based resin superior in transparency and weathering resistance. One type of either or a mixture may be used. The thickness is 10 to 100 μm, particularly preferably 20 to 50 μm. If too thin, problems arise in the weathering resistance and other performance, while if too thick, problems arise in terms of costs. Note that when weathering resistance is sought, the AE of the color difference due to 2000 hours of treatment of the substrate alone by a sunshine weather meter is preferably within at least 3. Further, if adding a UV absorbent, the weathering resistance is improved.

As the acryl-based resin, polymers of acrylic acid, methacrylic acid, or their methyl esters, ethyl esters, or other alkyl esters or copolymers of these monomers and comonomers of alkenylbenzenes or α,β-unsaturated monomers copolymerizable with the same may be illustrated. Further, as the urethane-based resin, a composition mainly comprised of a polyisocyanate, polyol, etc. (active hydrogen compound) may be mentioned.

The adhesive layer 14 bonds the back surface of the substrate 11 formed with the metal vapor deposited layer 20 and the backing material 15 and can be coated by a dry laminator. The adhesive is a binary curing type polyurethane-based adhesive etc. applied as necessary. The thickness after coating and drying is 1 to 10 μm, more preferably 2 to 7 μm. If less than 1 μm, a satisfactory bonding strength cannot be obtained, while if over 10 μm, there are problems from the viewpoint of production and cost.

The backing material 15 is selected in material, thickness, etc. in relation to the other material which the sparkling laminate film 10 of the present invention is to be bonded to with or cover. For example, when the sparkling laminate film 10 of the present invention is to be formed integrally with an article formed by extruding a polyvinyl chloride resin, a polyvinyl chloride resin film is preferably used as this backing material 15. As a general material, for example, among polyolefin-based resins, a resin containing a polypropylene resin and copolymer ingredient may be used. In addition, an ABS resin etc. may be used as the polymer alloy resin. As the required performance, heat resistance, water-proofness, etc. are required, so a heat resistance stabilizer etc. may also be contained.

The backing material 15 has a thickness of 30 to 500 μm, preferably 50 to 300 μm. If under 30 μm, the bonding performance is not satisfactory, while if over 500 μm, there are disadvantages in terms of production and cost. Further, the back surface of the backing material (side opposite to metal vapor deposited layer 20) may be primed to improve its bondability with a material used in later processing.

In the sparkling laminate film 10 of the present invention, one having a hue angle (H°) of a color and color difference meter L*C*H° color mode of a color difference meter when measuring the color of the transparent resin surface layer 30 in the range of 245 to 265, preferably in the range of 250 to 260, has a superior metallic gloss and is suitable for use as a sparkling laminate film 10 for an automobile.

Note that the front surface of the transparent resin surface layer 30 of the sparkling laminate film 10 is sometimes covered with a not shown protective substrate for the purpose of preventing scratching during the post-processing steps of the transparent resin surface layer 30 or during transport or storage. As this protective substrate, a polyester-based resin film containing a polyester-based resin film or a copolymer ingredient or a polypropylene resin film etc. is used. The protective substrate has a thickness of 9 to 100 μm, more preferably 12 to 75 μm. Under 9 μm, the protective function is not satisfactory, while over 100 μm, the cost is disadvantageous.

To form the sparkling laminate film 10 of the present embodiment, first, a polyester-based film (Teflex made by Teijin Dupont) of a thickness of 50 μm is prepared as the substrate 11 and formed with a metal vapor deposited layer 20 of a thickness of 400 Å by sputtering of chromium on the anti-lubricated surface of the substrate surface 11a (see FIG. 2). Next, an acryl-based resin is coated on the surface of the metal vapor deposited layer 20 by so-called doctor blade coating to a thickness of 30 μm (see FIG. 3). Note that as the primer serving as the intermediary between the organic resin and inorganic substance between the metal vapor deposited layer 20 and the transparent resin surface layer 30 at that time, for example a silane coupling agent may be used. The primer may be coated on the surface of the metal vapor deposited layer 20 thinly by for example gravure roll coating.

Further, a binary curing type urethane-based adhesive is coated on the back surface of the substrate formed with the metal vapor deposited layer 20 by a dry laminator and dried to form an adhesive layer 14 of a thickness of 4 μm, then this is bonded with a corona discharge treated surface of a polypropylene resin film of a thickness of 150 μm serving as the backing material 15 to thereby prepare the sparkling laminate film 10 such as shown in FIG. 1.

FIG. 4 shows a shaped article 40 comprised of a shaped article body 41 and the sparkling laminate film 10 integrally bonded to its surface. This shaped article 40 is for example an automobile molding. When extruding the molding body 41, the backing material of the sparkling laminate film 10 and the extruded article are integrally formed. This shaped article 40 exhibits a superior metallic gloss in its appearance and can greatly improve the decorativeness of the product.

Summarizing the effects of the invention, according to the sparkling laminate film of the present invention, it is possible to obtain a novel structure of a sparkling laminate film superior in weathering resistance while maintaining a superior metallic gloss even for long term use.

Further, according to the sparkling shaped article using this sparkling film, a tint or gloss can be provided to the appearance and a superior weathering resistance is imparted, so a high quality molding or other shaped article is obtained.

While the invention has been described with reference to specific embodiments chosen for purpose of illustration, it should be apparent that numerous modifications could be made thereto by those skilled in the art without departing from the basic concept and scope of the invention.

What is claimed is:

1. A sparkling laminate film comprised of a substrate, a metal vapor deposited layer formed on a front surface of said substrate, a transparent resin surface layer formed on the front surface of said metal vapor deposited layer, and a backing material integrally bonded to a back surface of said substrate through an adhesive layer.

2. A sparkling laminate film as set forth in claim 1, wherein said substrate is comprised of a polyester-based resin with a high flexibility.

3. A sparkling laminate film as set forth in claim 1, wherein said metal vapor deposited layer has a thickness of 150 to 750 Å.

4. A sparkling laminate film as set forth in claim 1, wherein said transparent resin surface layer is made of one of an acryl-based resin and a urethane-based resin.

5. A sparkling laminate film as set forth in claim 1, wherein a hue angle (H°) when measuring the color of said transparent resin surface layer is in a range of 245 to 265.

6. A sparkling shaped article comprised of a shaped body and a sparkling laminate film as set forth in claim 1 integrally bonded with that body.
